(19) United States
(12) Patent Application Publication
(10) Pub. No.: US 2007/0069642 A1
(43) Pub. Date: Mar. 29, 2007

(54) Sphere-supported thin film phosphor electroluminescent devices

(76) Inventors: Adrian Kitai, Mississauga (CA); Ying-wei Xiang, Hamilton (CA); Brian J. Cox, Halton Hills (CA)

Correspondence Address: Ralph A. Dowell of DOWELL & DOWELL P.C., 2111 Eisenhower Ave, Suite 406, Alexandria, VA, 22314, US

(21) Appl. No.: 10/570,516

(22) PCT Filed: Sep. 3, 2004
(86) PCT No.: PCT/CA04/01592

§ 371 Date: Oct. 25, 2006

Related U.S. Application Data
(60) Provisional application No. 60/500,375, filed on Sep. 5, 2003.

(51) Int. Cl. H01J 1/62

(52) U.S. Cl. 313/511; 313/498

(57) ABSTRACT

The present invention provides an electroluminescent display device using dielectric spheres embedded in a flexible electrically conducting substrate. Each of the spherical dielectric particles has a first portion protruding through a top surface of the substrate and a second portion protruding through the bottom surface of the substrate. An electroluminescent phosphor layer is deposited on the first portion of each spherical dielectric particles and a continuous electrically conductive, substantially transparent electrode layer is located on the top surfaces of the electroluminescent phosphor layer and areas of the flexible electrically insulating substrate located between the top surfaces of the electroluminescent phosphor layer. A continuous electrically conductive electrode layer coated on the second portion of the spherical dielectric particles and areas of the flexible, electrically insulated substrate located between the second portions of the spherical dielectric particles.

### CROSS REFERENCE TO RELATED U.S. PATENT APPLICATION

This patent application claims the priority benefit from U.S. Provisional Patent Application Ser. No. 60/500,375 filed on Sep. 5, 2003 entitled SPHERE-SUPPORTED THIN FILM PHOSPHOR ELECTROLUMINESCENT DEVICES, and which is incorporated herein in its entirety.

### FIELD OF THE INVENTION

The present invention relates to materials and structures for thin film electroluminescent devices, and more particularly the present invention relates to sphere-supported thin film phosphor electroluminescent (SSTFEL) devices.

### BACKGROUND OF THE INVENTION

Thin film electroluminescent (TFEL) devices typically consist of a laminar stack of thin films deposited on an insulating substrate. The thin films include a transparent electrode layer and an electroluminescent (EL) layer structure, comprising an EL phosphor material sandwiched between a pair of insulating layers. A second electrode layer completes the laminate structure. In matrix addressed TFEL panels the front and rear electrodes form orthogonal arrays of rows and columns to which voltages are applied by electronic drivers, and light is emitted by the EL phosphor in the overlap area between the rows and columns when sufficient voltage is applied in excess of a voltage threshold.

TFEL devices have the advantages of long life (50,000 hours or more to half brightness), wide operating temperature range, high contrast, wide viewing angle and high brightness.

In designing an EL device, a number of different requirements have to be satisfied by the substrates, the laminate layers and the interfaces between these layers. To enhance electroluminescent performance, the dielectric constants of the insulator layers should be high. To work reliably however, self-healing operation is desired, in which electric breakdown is limited to a small localized area of the EL device: The electrode material covering the dielectric layer fails at the local area, preventing further breakdown. Only certain dielectric and electrode combinations have this self-healing characteristic. At the interface between the phosphor and insulator layers, compatibility between materials is required to promote charge injection and charge trapping, and to prevent the interdiffusion of atomic species under the influence of the high electric fields during operation, and also at the temperatures required to fabricate the EL device.

Standard EL thin film insulators, such as SiO₂, Si₃N₄, Al₂O₃, SiOₓN_{y}, SiAlOₓN_{y} and Ta₂O₅ typically have relative dielectric constants (K) in the range of 3 to 60 which we shall refer to as low K dielectrics. These dielectrics do not always provide optimum EL performance due to their relatively low dielectric constants. A second class of dielectrics, called high K dielectrics, offer higher performance. This class includes materials such as SrTiO₃, BaTiO₃, PbTiO₃ which have relative dielectric constants generally in the range of 100 to 20,000, and are crystalline with the perovskite structure. While all of these dielectrics exhibit a sufficiently high figure of merit (defined as the product of the breakdown electric field and the relative dielectric constant) to function in the presence of high electric fields, not all of these materials offer sufficient chemical stability and compatibility in the presence of high processing temperatures that may be required to fabricate an EL device. Also, it is difficult to form high dielectric constant insulating jayers as thin films with good breakdown protection.

Substrates are also of fundamental importance for TFEL devices. Glass substrates are in commercial production. At temperatures significantly higher than 500° C., glass softens and mechanical deformation may occur due to stresses within the glass. For this reason, the maximum processing temperature of TFEL phosphors is of great significance. Yellow-emitting ZnS:Mn TFEL displays are compatible with glass substrates, however, many TFEL phosphors require higher processing temperatures. Example include blue emitting BaAl₂S₄:Eu, which is typically annealed at 750° C. (Noboru Miura, Mitsuhiro Kawanishi, Hironaga Matsumoto and Ryotaro Nakano, Jpn. J. Appi. Phys., Vol.38 (1999) pp. L1291-L1292), and green-emitting Zn₂Si_{0.5}Ge_{0.5}O₄:Mn, which is annealed at 7000° C. or more (A. H. Kitai, Y. Zhang, D. Ho, D. V. Stevanovic, Z. Huang, A. Nakua, Oxide Phosphor Green EL Devices on Glass Substrates, SID 99 Digest, p596-599).

Substrates other than glass may be used, and Wu in U.S. Pat. No. 5,432,015 teaches the application of ceramic substrates such as alumina sheets for TFEL devices. In such devices, thick film, high dielectric constant dielectrics are prepared. These dielectrics are in the range of 20 μm thick and are deposited by a combination of screen printing and sol-gel methods onto metallized alumina substrates, and are generally based on lead-containing materials such as PbTiO₃ and related compounds. Although, due to their thickness, these dielectrics offer good breakdown protection, they limit the processing temperature of phosphors that are on top of the dielectric layer, and phosphors that require processing temperatures of 700° C. or higher may be contaminated by the dielectric formulation at these temperatures. Also, substrate cost is much higher for ceramics than for glass, particularly for large size ceramics over ˜30 cm in length or width, since cracking and warping of large ceramic sheets is hard to control.

Although glass substrates may also be considered for processing temperatures at which they soften, (generally above 500 to 600° C.), warping or compaction of the glass will occur, particularly if longer annealing time are required.

Spray drying is a technique for ceramic synthesis that offers the ability to create spherical or almost spherical ceramic particles of a wide range of ceramic materials. It produces particles by atomizing a solution or slurry and evaporating moisture from the resulting droplets by suspending them in a hot gas. The schematic diagram of the spray drying apparatus is indicated in FIG. 1.

The spray drying process mainly comprises four main steps, each of which influences the final product properties. The four steps are: slurry preparation, atomization, evaporation and particle separation.

In the case of spraying drying BaTiO₃ particles, the quality of slurry has an important influence on the atomizing procedure and the properties of the final spherical particles (Stanley J. Lukasiewicz, “Spray-Drying Ceramic Powders”, J. Am. Ceram. Soc., 72(4) 617-624, 1989). The slurry is prepared from ultrafine BaTiO₃ primary particles dispersed in distilled water. Care is taken to make sure of uniformly dispersed slurry. If aggregates are present, they must be eliminated through a milling procedure. If necessary, organic dispersant should be added into the slurry, which could be absorbed on the surface of the particles by coulombic or Van der Waals forces or hydrogen bonding to keep the slurry in the deflocculated state. Two important properties of slurry are volume percent of solid and viscosity of slurry. These two conflicting parameters must be optimized to obtain optimum spray-dried particles.

Atomization takes place in \textcircled{2} of FIG. 1, generating a large number of small droplets from a bulk fluid. The resultant increase in the surface area-to-volume ratio allows rapid moisture removal from the droplets. As the feed is sprayed into the hot drying air (150˜200° C.) in \textcircled{7} of FIG. 1, a saturated vapour film is quickly established at the surface of each droplet in the spray. Evaporation is generally completed within 10˜30 seconds, which is the time for drying gas to pass from inlet to outlet of the drying chamber. Then, dried particles are separated from drying air and collected in a cyclone separator (\textcircled{8} \textcircled{9} of FIG. 1 ).

The main advantages of spray drying are spherical or near-spherical particle shape and closely controlled particle size distribution over range 10-500 μm (David. E. Oakley, “produce uniform particles by spray drying”, Chemical engineering progress, Oct., p48-54, 1997). The surface finish of spray-dried particles can be controlled by adjusting processing parameters. Grain size of the particles can be maintained in sub-micron range by adjusting the starting primary particles. Sintering of the ceramic particles is accomplished after spray drying, and grain growth is generally observed to depend on sintering temperature and time.

Flexible polymer substrates for electronic displays are desireable due to their low cost, low weight and robustness. For vehicles they also offer safety advantages in that glass-related injury is eliminated. Manufacturing of displays on flexible substrates also offers the promise of roll-to-roll processing which is a low cost volume production method.

EL devices on plastic substrates are well known in which a powder phosphor layer is deposited between two electrodes. These are known as powder EL devices that are used in low brightness lamps and backlights for liquid crystal displays.

Present powder EL lamps are based on ZnS:Cu (S. Chadha, Solid State Luminescence, A. H. kitai, editor, Chapman and Hall, pp. 159-227). In these powders, Cu₂₋ₓS forms inclusions as shown in FIG. 2, which act as electric field intensifiers since they are sharp-tipped conductors (tip radius ≦50 angstroms).

During operation, these Cu₂₋ₓS tips lose their sharpness, and the electric field decreases, resulting in weaker luminescence. In careful observation using an optical microscope, A. G. Fischer (A. G. Fischer, J. Electrochem. Soc., 118, 1396, 1971) saw comet-shaped light emission extending away from the tips, which decreased in length as the phosphor aged.

Other reports (S. Roberts, J. AppL Phys., 28, 245, 1957) suggested ion diffusion and linked deterioration of these phosphors to moisture.

The observed time-dependent luminance available from powder EL is shown in FIG. 3.

By suitable co-activation in ZnS:Cu with Cl, Mn and other ions, the colour may be altered to achieve blue, green and yellow emission (see Table 1).

TABLE 1
Powder phosphors known to exhibit EL.

| Phosphor | Excitation | Colour |
|---|---|---|
| ZnS:Cu, Cl(Br, I) | AC | Blue |
| ZnS:Cu, Cl(Br, I) | AC | Green |
| ZnS:Cu, Cl | AC | Yellow |
| ZnS:Cu, Cu, Cl | AC and DC | Yellow |
| ZnSe:Cu, Cl | AC and DC | Yellow |
| ZnSSe:Cu, Cl | AC and DC | Yellow |
| ZnCdS:Mn, Cl(Cu) | AC | Yellow |
| ZnCdS:Ag, Cl(Au) | AC | Blue |
| ZnS:Cu, Al | AC | Blue |

FIG. 4 shows a typical commercial lamp. There have been no fundamental improvements in luminance or stability since the 1950's, although improved encapsulation technology has been developed to reduce moisture penetration.

Therefore, it would be very advantageous to provide a TFEL device structure in which no high temperature substrate is necessary, and which offers mechanical flexibility. Such a device would possess the excellent stability, high brightness and threshold-voltage characteristics of TFEL devices, along with the low cost, light weight and robustness of a plastic substrate.

### SUMMARY OF THE INVENTION

It is an object of the present invention to develop SSTFEL devices that include substantially spherical dielectric particles (preferably spherical BaTiO₃ particles) and polymer substrates.

To achieve this objective, spherical spray-dried BaTiO₃ particles were used as the starting material. After sintering and sieving, an oxide phosphor layer was deposited and annealed on the top surface of mono-dispersed BaTiO₃ spheres. The phosphor-coated spheres were subsequently embedded into polypropylene film. This functional SSTFEL device was finished by depositing a front transparent ITO electrode and a rear gold electrode.

The present invention provides an electroluminescent display device, comprising;

a flexible, electrically insulated substrate having opposed surfaces;

an array of generally spherical dielectric particles embedded in the flexible, electrically insulated substrate with each of the spherical dielectric particles having a first portion protruding through one of the opposed surfaces and a second portion protruding through the other of said opposed surfaces;

an electroluminescent phosphor layer deposited on the first portion of each spherical dielectric particles;

a continuous electrically conductive, substantially transparent electrode layer located on the top surfaces of the electroluminescent phosphor layer and areas of the flexible electrically insulating substrate located between the top surfaces of the electroluminescent phosphor layer; and

a continuous electrically conductive electrode layer coated on the second portion of the spherical dielectric particles and areas of the flexible, electrically insulated substrate located between the second portions of the spherical dielectric particles, means for applying a voltage between the continuous electrically conductive, substantially transparent electrode layer and the continuous electrically conductive electrode layer.

The present invention also provides a capacitor, comprising;

a flexible, electrically insulated substrate having opposed surfaces;

an array of generally spherical dielectric particles embedded in the flexible, electrically insulated substrate with each of the spherical dielectric particles having a first portion protruding through one of the opposed surfaces and a second portion protruding through the other of said opposed surfaces;

a first continuous electrically conductive layer covering the first portion of the spherical dielectric particles and areas of the flexible electrically insulating substrate located between the first portions of the spherical dielectric particles;

a continuous electrically conductive electrode layer covering the second portions of the spherical dielectric particles and areas of the flexible, electrically insulated substrate located between the second portions of the spherical dielectric particles.

The present invention also provides a p-n semiconductor device, comprising;

a flexible, electrically insulated substrate having opposed surfaces;

an array of generally spherical semiconductor particles made of an n-type semiconductor embedded in the flexible, electrically insulated substrate with each of the spherical semiconductor particles having a first portion protruding through one of the opposed surfaces and a second portion protruding through the other of said opposed surfaces;

p-type semiconductor layer deposited on the first portion of each spherical semiconductor particles;

a first continuous electrically conductive electrode layer located on the top surfaces of the p-type semiconductor layer and areas of the flexible electrically insulating substrate located between the top surfaces of the p-type semiconductor layer; and

a second continuous electrically conductive electrode layer coated on the second portion of the spherical semiconductor particles and areas of the flexible, electrically insulated substrate located between the second portions of the spherical semiconductor particles, means for applying a voltage between the first and second continuous electrically conductive electrode layers.

### BRIEF DESCRIPTION OF THE DRAWINGS

The invention will now be described, by way of example only, reference being had to the accompanying drawings, in which:

FIG. 1 is schematic diagram of a spray drying system used for producing the spherical dielectric particles used in the present invention;

FIG. 2 shows prior art Cu₂₋ₓS inclusions in ZnS:Cu powder phosphor;

FIG. 3 is a graph showing maintenance curve of prior art powder EL cell;

FIG. 4 is the structure of typical prior art AC powder EL lamp with flexible plastic and foil construction;

FIG. 5 is schematic diagram of a SSTFEL structure produced in accordance with the present invention;

FIG. 6a is cross-sectional view of another embodiment of an SSTFEL structure;

FIG. 6b is top view of an embodiment of SSTFEL structure;

FIG. 7 shows a high purity Al₂O₃ plate with 54 μm diameter, and 18 μm deep pits used in the process of preparing SSTFEL displays in accordance with the present invention;

FIG. 8 shows an embedding process to prepare pp-BT composite sheet;

FIG. 9 shows a plot of Luminance and luminous efficiency of SSTFEL displays driven at 60 Hz;

FIG. 10 shows a plot of Luminance and luminous efficiency of SSTFEL displays driven at 600 Hz;

FIG. 11 shows a schematic diagram of an SSTFEL structure with a double ITO layer;

FIG. 12 shows a schematic diagram of the procedure making a flexible TFEL display with polypropylene-ceramic composite structure;

FIG. 13 shows a schematic diagram of further steps in the procedure for making a flexible TFEL display with polypropylene-ceramic composite structure;

FIG. 14 shows a schematic diagram of further steps in the procedure for making a flexible TFEL display with polypropylene-ceramic composite structure; and

FIG. 15 shows the structure of the SSTFEL device produced using the steps shown in FIGS. 12 to 14.

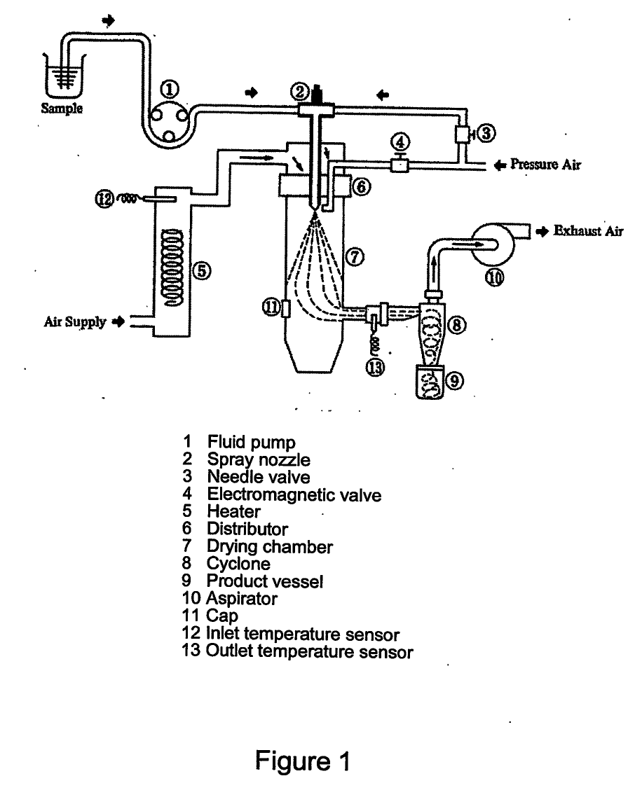

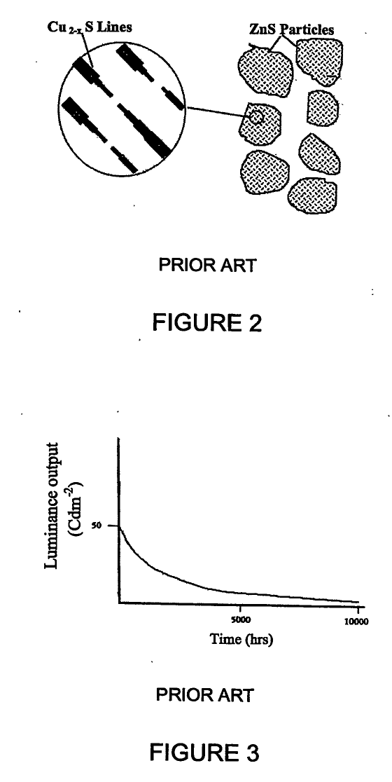

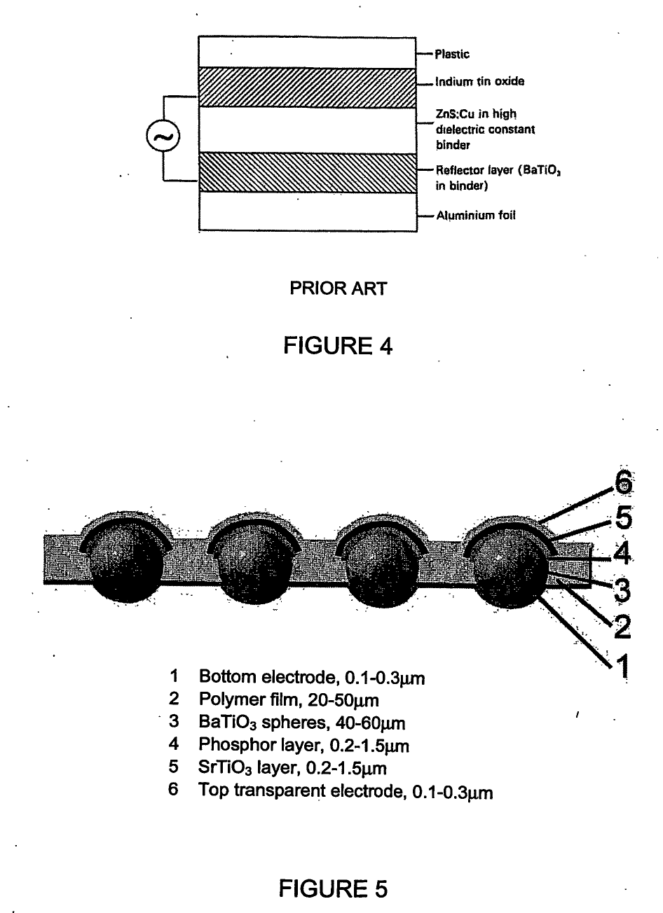

### DETAILED DESCRIPTION OF THE INVENTION

The inventors have shown for the first time that thin film phosphor electroluminescent devices can be prepared using dielectric spheres, preferably BaTiO₃ spheres for electroluminescent (EL) display applications. The device possesses a novel structure and is prepared through a special processing route in order to perform high temperature annealing processes required before applying the spheres into a low temperature substrate.

FIG. 5 shows the schematic diagram of the proposed structure of the Sphere-Supported Thin Film Electroluminescent (SSTFEL) device. A phosphor layer 4 is deposited onto the top surface of BaTiO₃ spheres 3. In a preferred embodiment a thin SrTiO₃ layer 5 is deposited onto the phosphor layer for effective charge injection into the phosphor layer. The BaTiO₃ spheres are embedded within a polymer layer 2 with the top and bottom areas of the BaTiO₃ spheres exposed. The top area of the BaTiO₃ spheres and the surrounding polymer is coated with transparent electrically conducting electrode 6; the bottom area of the BaTiO₃ spheres and surrounding polymer is coated with another electrically conducting electrode 1, which may be opaque. The preferred thickness ranges for each of the components comprising the SSTFEL structure are shown to the right of the corresponding components in FIG. 5.

Any EL phosphor material may be used including but not limited to metal oxide or sulphide based EL materials. For example, the sulphide phosphor may be any one of ZnS:Mn or BaAl₂S₄:Eu, or BaAl₄S₇:Eu. The oxide phosphors may preferably be any one of Zn₂Si_{0.5}Ge_{O.5}O₄:Mn, Zn₂SiO₄:Mn, or Ga₂O₃:Eu and CaAl₂O₄:Eu.

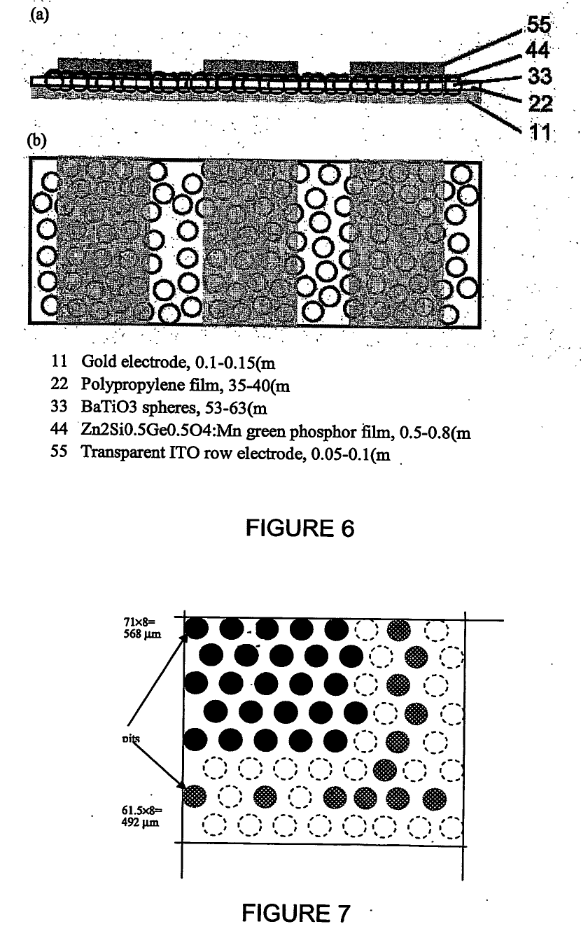

A specific embodiment of the SSTFEL structure that has been fabricated and tested is shown in FIG. 6. Isolated BaTiO₃ spheres 33 are embedded in the polypropylene film 22, which does not cover the top and bottom areas of BaTiO₃ spheres. The top surface area of the spheres is coated with green oxide phosphor layer 44 which is Zn₂Si_{0.5}Ge_{0.5}O₄:Mn. SrTiO₃ was not deposited on the oxide phosphor layer. The whole bottom surface area of the BaTiO₃ spheres and polypropylene film are coated with a gold layer 11. The top transparent electronically conducting electrode is deposited ITO layer 55. The thickness ranges for each of the components are shown in FIG. 6.

Details of a non-limiting, exemplary fabrication process will now be provided.

Spray-dried BaTiO₃ particles used comprise NanOxidem™ HPB-1000 Barium Titanate Powder (Lot# BTA020516AC), which is produced by TPL, Inc. The particles had almost spherical shape, very smooth surface, and a large size distribution range of approximately 1˜120μm. While spherical particles are preferred, it will be understood that the particles do not need to be perfectly spherical and for example may be slightly ellipsoidal or flattened in shape.

Sintering of the as-received spheres was performed at 1120° C. for 2 hours in air within an open-end furnace. The shrinkage due to sintering is approximately 20%, grain size after sintering is 0.4˜0.8 μm and surface roughness is less than 0.5 μm. Sintered BaTiO₃ spheres with size range of 53˜63μm were selected by U.S.A standard test sieves (Laval Lab Inc).

In order to make a specific positional arrangement of BaTiO₃ spheres embedded in the polypropylene film, a pattern of circular depressions is used to hold BaTiO₃ spheres on an alumina substrate during the sputtering, annealing and embedding processes. This pattern of circular depressions on a high purity Al₂O₃ plate is shown in FIG. 7. The 54 μm diameter, and 18 μm deep pits are arranged to form an array of closely-spaced 5×5 units. The horizontal and vertical distances between each unit are 284 μm and 246 μm respectively. Each pit is 71 μm away from another pit within one unit based on a cenre-to-centre distance. A few BT spheres are intentionally arranged among units in order to facilitate the subsequent embedding process.

To provide a sufficient bond for each BaTiO₃ sphere to stay in each pit, a polymer is melted into each pit first. In order to keep the alumina surface between pits from being covered by polymer, solid poly (α-methylstyrene) [PAMS, Mw=80, 800, d=1.075] powder is used to accomplish the patterning process, and is introduced into the pits and then melted. The PAMS powder is prepared by mechanical pulverization of PAMS pellets. Particle size is approximately in the range of 1˜10 μm. It has no specific melting point. There is a temperature range (˜50° C.) between softening point and fully melted state.

At room temperature, solid PAMS powder is put into each pit and there is little PAMS powder on the surface area among pits. Then, still at room temperature, BaTiO₃ spheres are spread onto the Al₂O₃ plate to form one layer of a closed packed pattem. After increasing the temperature to ˜115° C., PAMS powder in each pit forms an adhesive gel. When BaTiO₃ spheres are pressed gently, one sphere adheres to each pit. After cooling to room temperature, excess BaTiO₃ spheres is brushed away, leaving the same pattern of spheres as that of pits indicated in FIG. 7.

After patteming, the Al₂O₃ plate loaded with BaTiO₃ spheres and is baked at 1000°C. for 10 minutes in air to bum off the PAMS completely. After baking, the spheres are still weakly adhered to the Al₂O₃ plate due to weak bonding forces that result from the bum-off of PAMS. The sticky force is large enough to keep the spheres stationary during the following sputtering, annealing and embedding processes.

A 50 nm thick Al₂O₃ barrier layer was first deposited on the top area of BT spheres by RF sputtering, followed by a green emitting Zn₂Si_{0.5}Ge_{0.5}O₄:Mn phosphor layer sputtered in the same chamber. The spheres were kept at 250° C. and the EL film thickness was about 800 μm. After sputtering, the spheres, still sitting on the Al₂O₃ plate, were annealed at 800° C. for 12 hours in vacuum with an oxygen pressure of 2.0×10⁻⁴Torr. This annealing procedure is to activate and crystallize the phosphor layer. The Al₂O₃ barrier layer improves the phosphor performance since it acts as a diffusion barrier between the BT and the phosphor.

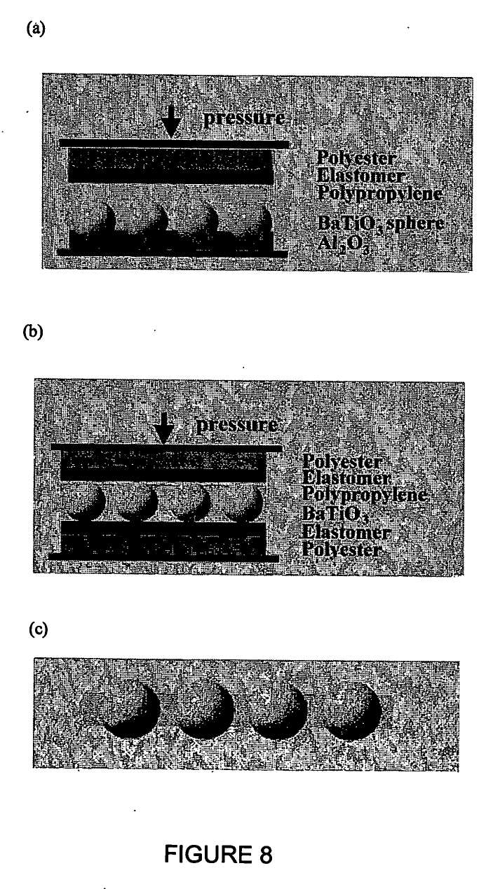

After annealing, the procedure to embed phosphor-coated BaTiO₃ spheres into a polypropylene film is shown in FIG. 8. A 25.4 μm-thick biaxially oriented polypropylene film (TRANSPROP™ OL polypropylene from Transilwrap Company, Inc.) was placed over the phosphor-coated BT spheres. Then a Gel-Pak sheet which comprises an elastic, gel-like, adhesive polymer layer 1 supported by a polyester sheet 2 (GEL-FILM™ WF-40/1.5-X4 from Gel-Pak Inc.) was placed on the top of the polypropylene film. A pressure of 180 g/cm² was applied on the back of polyester sheet to hold this structure together. After heating the whole structure at ˜200° C. for 5 minutes, the polypropylene film melted and filled in between the spheres under the pressure. After cooling, a pp-BT composite sheet was peeled off. Next, this composite sheet was sandwiched between two Gel-Pak sheets. Pressing the sandwich structure under 180 g/cm₂, this composite sheet was heated and melted again so that the pp moves to the centre of the composite sheet. Note that the top and bottom areas of the spheres are not covered by polypropylene film. The adhesive layer of the Gel-Pak film is elastic and deforms under pressure. It can effectively protect the top and bottom area of the spheres from being covered with polymer. Moreover, the resultant polypropylene film could be easily peeled off from this Gel-Pak adhesive layer without any damage.

After the resultant film of FIG. 8c was obtained, a thin layer of gold (100 nm) was sputtered onto the bottom area of the film. A transparent ITO electrode (100 nm) was sputtered onto the top area of the film. When an AC voltage of between 150 and 300 volts peak was applied across the ITO and gold electrodes, bright green light was emitted from the top area of the spheres.

It can be seen that the exposed top and bottom areas of the BT spheres are symmetric with the pp film. The thickness of the composite film is dependent on the original pp film thickness, BT sphere density, applied pressure and other processing parameters during the embedding process.

When an AC applied voltage is above the threshold value across the ITO and gold electrodes, the phosphor-coated top area of each individual BT sphere emits green EL. It is observed in prototype devices that the light-emitting area varies in each BT sphere due to variations of the size of BT spheres and the uniformity of the pp-BT composite film which also affects the size of the light-emitting area.

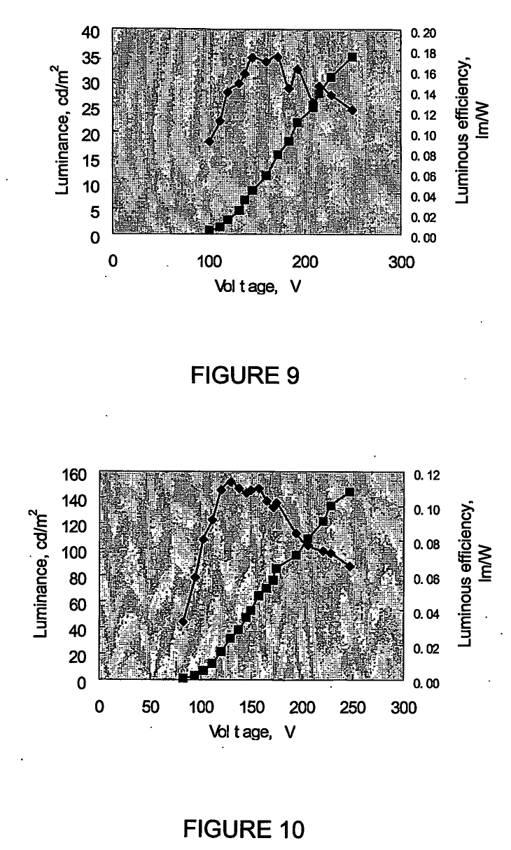

FIG. 9 shows the average luminance and luminous efficiency as a function of peak applied voltage. The frequency of the driving voltage is 60 Hz. Average luminance of the SSTFEL device could reach 35 cd/m² driven at 250 volts. The highest luminous efficiency is about 0.18 Im/W. When driven at 600 Hz, luminance reaches over 150 cd/m² as shown in FIG. 10.

It should be noted that a transparent, thin film dielectric layer deposited on top of the phosphor layer is generally understood to improve the EL characteristics, and should be considered as within the scope of this invention. As mentioned above, although an oxide EL phosphor was used in some of the examples disclosed herein, other EL materials may be used such as sulphide phosphors.

The spheres may also be coated by thin film phosphor and dielectric layers using other methods. For example, instead of sputtering, films may be grown by evaporation or chemical vapour deposition techniques.

Rather than only coating the top portion of the spheres, the thin film EL phosphor and thin film dielectric layers may be coated uniformly on the entire surface of the spheres. This may be achieved by rolling the spheres during deposition, or by using a chemical vapour deposition process with the spheres in a fluid bed allowing the vapour stream to pass through the bed. After embedding the spheres into the polymer substrate the portion of the spheres protruding from the back of the polymer film may be etched in a weak acid, for example, to remove the thin films in this region, resulting in a structure very similar to that shown in FIG. 7. The advantage of this approach would be that the coated spheres would not require any orientation prior to being embedded into the polymer, and could therefore be prepared as a loose powder. If the etching step is omitted, light will be generated at both the upper and lower phosphor areas of each spheres.

Dielectric materials other than barium titanate could be employed to make spheres such as strontium titanate (SrTiO₃) and lead zirconium-titanates (Pb(Zr,Ti)O₃), for example. The diameter of the spheres could be as small as about 5 microns or as large as about 500 microns.

Polymers other than polypropylene could be employed. Possible materials include polyethylene, polystyrene or polyester. In general, electrically insulating polymers capable of bonding to the spheres and being coated with electrode layers could be employed. For maximum contrast, or for specific applications black or coloured polymers could be considered, to give the resulting EL device a specific black or coloured appearance.

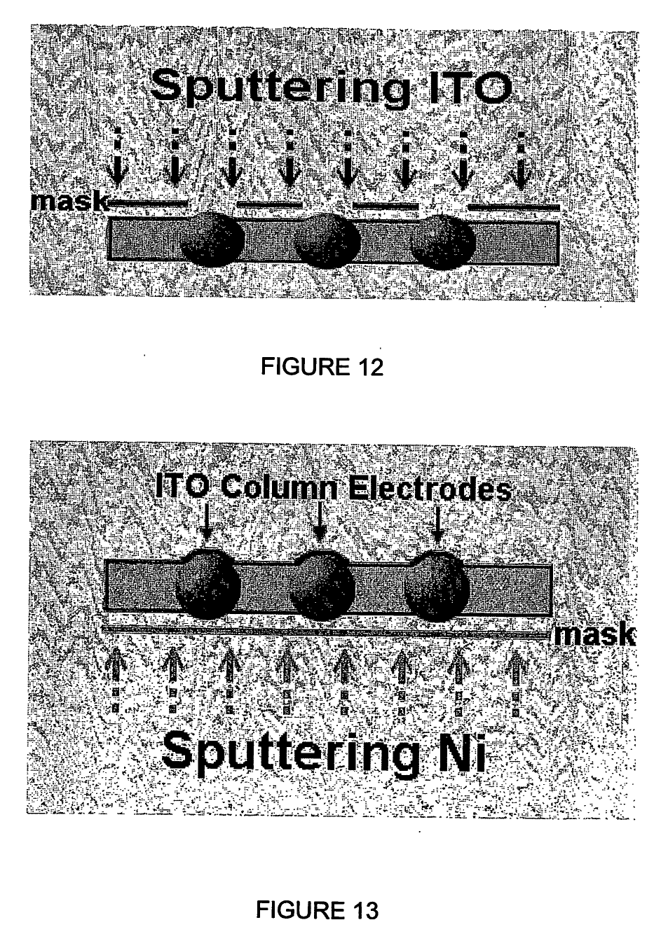

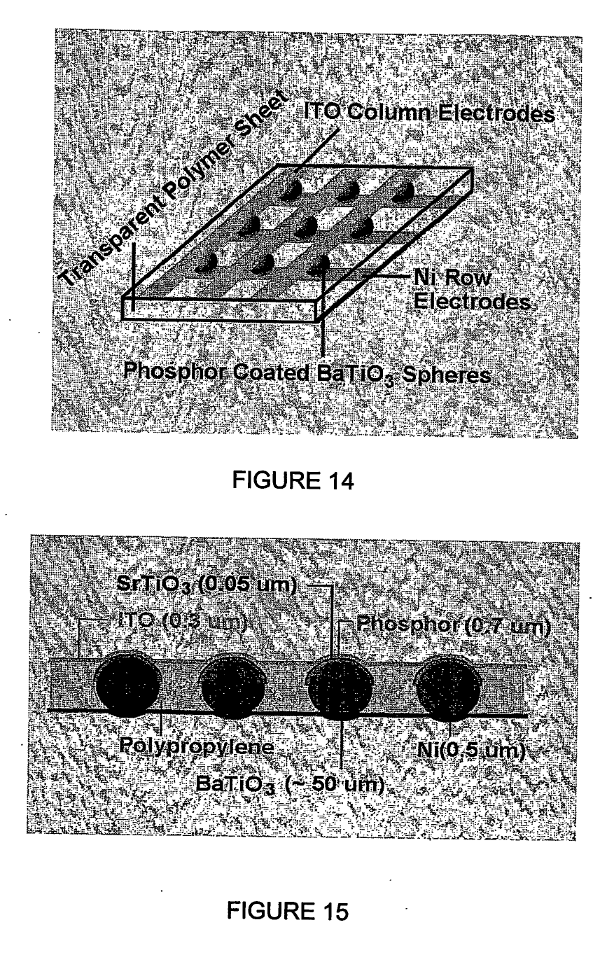

Spheres emitting several different colours could be deposited into the polymer in a spatially patterned manner. For example, red, green and blue emitting EL phosphors are known, and could be arranged in pixels to form an array of picture elements capable of representing colour images. Each pixel could consist of one sphere emitting each colour, or of many spheres emitting each colour. By depositing row and column electrodes appropriately placed relative to the various colour-emitting regions of the EL device, a colour EL display that can be addressed electronically may be realized, see FIGS. 12 to 14 showing details of fabricating such EL display arrays.

Patterning of the spheres of various colours could be achieved using well known printing methods for inks and toners. These include silk-screening and printing from metal plates, as well as the photocopying processes in which electrically charged toners are electrostatically patterned by means of a photosensitive plate or drum.

Spheres emitting various colours could be blended to achieve a desired pre-selected colour due to the combination of two or more colours.

Additional protective layers of suitable materials such as polymer or glass sheets could be added above and below the EL device to provide electrical protection or to provide for a sealed device.

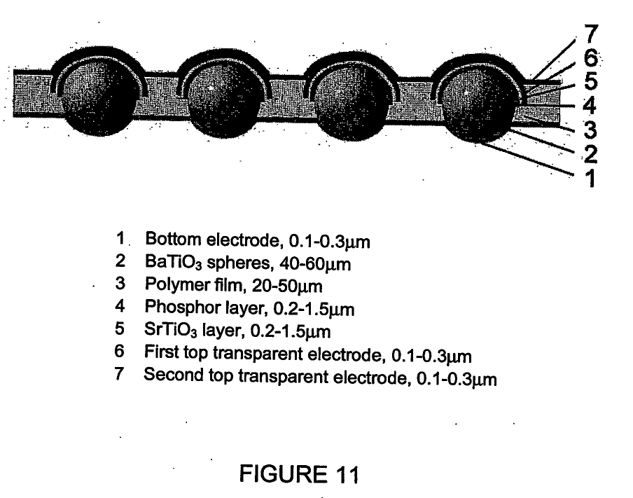

An improvement to the device of FIG. 5 may be made as shown in FIG. 11. In this embodiment, a more complex ITO electrode is used which prevents undesirable high electric fields that may develop across the polymer in the regions near the phosphor coated surface of the BT spheres. This ITO coating could be deposited using, by way of example, the following process: Firstly, the phosphor 4 coated spheres 2 could be embedded into the polymer sheet 3 such that almost half the spheres protruded on the front side of the polymer sheet. A first transparent ITO top electrode 6 is then be sputtered onto one side of the spheres, and subsequently the spheres are embedded symmetrically such that the front and back of each sphere were equally protruding. Then a second transparent ITO top electrode 7 in electrical contact with the first transparent ITO top electrode would be sputtered. Finally, a bottom electrode 1 would be sputtered to form the structure of FIG. 11. The use of both front electrodes at 6 and 7 prevents high electric fields from being present in the polymer during electrical operation of the device.

It is also anticipated by the inventors that alternative uses of the spherical structures provided herein exist. For example, referring to FIG. 7b, if the BaTiO₃ is replaced with an n-type semiconductor, and the phosphor layer were replaced with a p-type semiconductor, then a p-n junction diode device could be formed in each sphere. A semiconductor of interest could be GaₓIn₍₁₋ₓ₎N which is known to provide for efficient light emission in diode devices.

The portion of the spheres protruding from the back of the polymer film could also be used to advantage. For-example, a thin film of a suitable semiconducting material could be grown such that it provided switching characteristics to improve the matrix addressing properties of a display device which had many row and column electrodes. Other switching devices could also be formed by a patterning process on the said portion of the spheres to create circuitry capable of controlling the electric current flowing through each sphere, or allowing each sphere to become a device that could store information relevant to its brightness level.

In the examples presented above, the portions of the spheres protruding from the front and back of the polymer film were about equal in area. However if in FIG. 8b) the elastomer layers of two Gel-Pak sheets had different elastomeric characteristics, it would be possible to provide for different areas of the portions of the spheres protruding from the front and back of the polymer film. This could be used to optimize display performance or properties.

All the above description relates to visual display applications of this technology. With appropriate modifications, other applications could include flexible capacitors. The capacitor would be formed as shown at 50 in FIG. 11, but would differ from the EL device in that the transparent electrode 6 on the top of the spheres/polymer film (FIG. 5) would be replaced by a metal electrode and there would be no phosphor layer. The completed capacitor can now be laminated onto a printed circuit board, or even within the layers of a printed circuit board to realize an integrated capacitor. A review of other approaches to the integrated capacitor (R. IEEE Spectrum Magazine, Jul., 2003, pp26-30) generally involve the use of a glass or ceramic layer deposited on a metal foil which can crack and therefore fail, whereas this invention avoids this problem by the natural flexibility of the polymer film between the ceramic spheres. Generally high values of capacitance may be achieved using high dielectric constant ceramics such as BaTiO₃ for the spheres. The diameter of the spheres may also be small, such as 10 μm, to further increase capacitance. In many cases only low voltages of 1-5 volt need to be applied to these capacitors, permitting the use of smaller spheres and a correspondingly thinner polymer film. These capacitors could be used in printed circuit boards (i.e. incorporated as a dielectric layer within the circuit board laminate) for circuit applications requiring a high performance capacitor that doesn't occupy circuit board space like a regular capacitor mounted on the board. In addition, since leads between the capacitor and the circuit board are eliminated, the usual parasitic inductance associated with the capacitor is minimized.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims.

1. An electroluminescent display device, comprising;
a flexible, electrically insulated substrate having opposed surfaces;
an array of generally spherical dielectric particles embedded in the flexible, electrically insulated substrate with each of the spherical dielectric particles having a first portion protruding through one of the opposed surfaces and a second portion protruding through the other of said opposed surfaces;
an electroluminescent phosphor layer deposited on the first portion of each spherical dielectric particles;
a continuous electrically conductive, substantially transparent electrode layer located on the top surfaces of the electroluminescent phosphor layer and areas of the flexible electrically insulating substrate located between the top surfaces of the electroluminescent phosphor layer;
a continuous electrically conductive electrode layer coated on the second portion of the spherical dielectric particles and areas of the flexible, electrically insulated substrate located between the second portion of the spherical dielectric particles, means for applying a voltage between the continuous electrically conductive, substantially transparent electrode layer and the continuous electrically conductive electrode layer.

2. The electroluminescent display device according to claim 1 wherein the generally spherical dielectric particles have a relative permittivity of between about 100 to about 25,000.

3. The electroluminescent display device according to claim 1 wherein the generally spherical dielectric particles have a relative permittivity of between about 1000 to about 10,000.

4. The electroluminescent display device according to claim 1, wherein generally spherical dielectric particles are BaTiO₃ particles.

5. The electroluminescent display device according to claim 4 wherein BaTiO₃ particles have a diameter in a range from about 40 to 70 microns.

6. The electroluminescent display device according to claim 1, including a layer of SrTiO₃ interposed between the electroluminescent phosphor layer and the electrically conductive, substantially transparent electrode.

7. The electroluminescent display device according to claim 1 including a layer of a dielectric material interposed between the electroluminescent phosphor layer and the electrically conductive, substantially transparent electrode, wherein the dielectric material is selected from the group consisting of SrTiO₃, Ta₂O₅ and Y₂O₃.

8. The electroluminescent display device according to claim 7 wherein the layer of a dielectric material has a thickness in a range from about 0.2 to about 1.5 micrometers.

9. The electroluminescent display device according to claim 1, wherein the flexible, electrically insulated substrate has a thickness in a range from about 20 to about 50 micrometers.

10. The electroluminescent display device according to claim 1 wherein the flexible, electrically insulated substrate is a polymer.

11. The electroluminescent display device according to claim 10 wherein the polymer is polypropylene.

12. The electroluminescent display device according to claim 11 wherein the polypropylene has a thickness in a range from about 20 to about 50 micrometers.

13. The electroluminescent display device according to claim 1 wherein the continuous electrically conductive, substantially transparent electrode layer and the continuous electrically conductive electrode layer each have a thickness in a range from about 0.1 to about 0.5 micrometers.

14. The electroluminescent display device according to claim 1 wherein the electroluminescent phosphor layer has a thickness in a range from about 0.2 to about 1.5 micrometers.

15. The electroluminescent display device according to claim 1 wherein the electroluminescent phosphor layer is light emitting oxide phosphor selected from the group consisting of Zn₂Si_{0.5}Geo_{0.5}0₄:Mn, Zn₂SiO₄:Mn, or Ga₂O₃:Eu and CaAl₂O₄:Eu.

16. The electroluminescent display device according to claim 1 wherein the electrically conductive, substantially transparent electrode layer is indium tin oxide (ITO).

17. The electroluminescent display device according to claim 1 wherein the continuous electrically conductive electrode layer is made of a metal selected from the group consisting of qold, silver, nickel and copper.

18. The electroluminescent display device according to claim 1 wherein generally spherical dielectric particles are selected from the group consisting of strontium titanate (SrTiO₃) and lead zirconium-titanates (Pb(Zr,Ti)O₃).

19. The electroluminescent display device according to claim 10 wherein the polymer is selected from the group consisting of polyethylene, polystyrene and polyester.

20. The electroluminescent display device according to claim 1 wherein the electroluminescent phosphor layer is a sulphide phosphor.

21. The electroluminescent display device according to claim 20 wherein the sulphide phosphor is selected from the group consisting of ZnS:Mn or BaAl₂S₄:Eu, and BaAl₄S₇:Eu.

22. The electroluminescent display device according to claim 1 wherein the first portion protruding through one of the opposed surfaces and the second portion protruding through the other of the opposed surfaces have different surface areas.

23. The electroluminescent display device according to claim 1 wherein the continuous electrically conductive, substantially transparent electrode layer located on the top surfaces of the electroluminescent phosphor layer and areas of the flexible electrically insulating substrate located between the top surfaces of the electroluminescent phosphor layer is a first electrode layer, and wherein each generally spherical dielectric particle includes a second electrode layer including a second electrically conductive, substantially transparent electrode layer located between the top surfaces of the electroluminescent phosphor layer and the first electrode layer extending hemispherically around a portion of the generally spherical dielectric particles so that when said generally spherical dielectric particles are embedded in the flexible, electrically insulated substrate the second electrode layer extends below a surface of the flexible insulating substrate into the interior thereof.

24. A capacitor, comprising;
a flexible, electrically insulated substrate having opposed surfaces;
an array of generally spherical dielectric particles embedded in the flexible, electrically insulated substrate with each of the spherical dielectric particles having a first portion protruding through one of the opposed surfaces and a second portion protruding through the other of said opposed surfaces;
a first continuous electrically conductive layer covering the first portion of the spherical dielectric particles and areas of the flexible electrically insulating substrate located between the first portion of the spherical dielectric particles;
a second continuous electrically conductive electrode layer covering the second portion of the spherical dielectric particles and areas of the flexible, electrically insulated substrate located between the second portion of the spherical dielectric particles, means for applying a voltage between the first and second continuous electrically conductive electrode layers.

25. The capacitor according to claim 24 wherein the generally spherical dielectric particles are spherical BaTiO₃ particles.

26. The capacitor according to claim 25 wherein the BaTiO₃ particles have a diameter in a range from about 40 to 70 microns.

27. A p-n semiconductor device, comprising;
a flexible, electrically insulated substrate having opposed surfaces;
an array of generally spherical semiconductor particles made of an n-type semiconductor embedded in the flexible, electrically insulated substrate with each of the spherical semiconductor particles having a first portion protruding through one of the opposed surfaces and a second portion protruding through the other of said opposed surfaces;
p-type semiconductor layer deposited on the first portion of each spherical semiconductor particles;
a first continuous electrically conductive electrode layer located on the top surfaces of the p-type semiconductor layer and areas of the flexible electrically insulating substrate located between the top surfaces of the p-type semiconductor layer; and
a second continuous electrically conductive electrode layer coated on the second portion of the spherical semiconductor particles and areas of the flexible, electrically insulated substrate located between the second portion of the spherical semiconductor particles, means for applying a voltage between the first and second continuous electrically conductive electrode layers.

28. The p-n semiconductor device according to claim 27 wherein the semiconductor is GaₓIn₍₁₋ₓ₎N.

29. An addressable electroluminescent display device, comprising;
a flexible, electrically insulated substrate having opposed surfaces;
an array of generally spherical dielectric particles embedded in the flexible, electrically insulated substrate with each of the spherical dielectric particles having a first portion protruding through one of the opposed surfaces and a second portion protruding through the other of said opposed surfaces;
an electroluminescent phosphor layer deposited on the first portion of each spherical dielectric particles;
electrically conductive, substantially transparent row electrode layers located on the top surfaces of the electroluminescent phosphor layer and extending in substantially parallel rows to each other,
electrically conductive column electrode layers coated on the second portion of the spherical dielectric particles in columns perpendicular to the row electrodes so that each spherical dielectric particle in the array is addressable by one of the row and column electrodes, means for applying a voltage between the row and column electrodes.

30. The addressable electroluminescent display device according to claim 29 wherein the generally spherical dielectric particles have a relative permittivity of between about 100 to about 25,000.

31. The addressable electroluminescent display device according to claim 29 wherein the generally spherical dielectric particles have a relative permittivity of between about 1000 to about 10,000.

32. The addressable electroluminescent display device according to claim 29 wherein generally spherical dielectric particles are BaTiO₃ particles.

33. The addressable electroluminescent display device according to claim 32 wherein BaTiO₃ particles have a diameter in a range from about 40 to 70 microns.

34. The addressable electroluminescent display device according to claim 29 including a layer of SrTiO₃ interposed between the electroluminescent phosphor layer and the electrically conductive, substantially transparent row electrode layers.

35. The addressable electroluminescent display device according to claim 29 including a layer of a dielectric material interposed between the electroluminescent phosphor layer and the electrically conductive, substantially transparent row electrode layers, wherein the dielectric material is selected from the group consisting of SrTiO₃,Ta₂O₅ and Y₂O₃.

36. The addressable electroluminescent display device according to claim 35 wherein the layer of a dielectric material has a thickness in a range from about 0.2 to about 1.5 micrometers.

37. The addressable electroluminescent display device according to claim 29 wherein the flexible, electrically insulated substrate has a thickness in a range from about 20 to about 50 micrometers.

38. The addressable electroluminescent display device according to claim 29 wherein the flexible, electrically insulated substrate is a polymer.

39. The addressable electroluminescent display device according to claim 38 wherein the polymer is polypropylene.

40. The addressable electroluminescent display device according to claim 39 wherein the polypropylene has a thickness in a range from about 20 to about 50 micrometers.

41. The addressable electroluminescent display device according to claim 29 wherein the electrically conductive, substantially transparent row electrode layers and the electrically conductive column electrode layers each have a thickness in a range from about 0.1 to about 0.5 micrometers.

42. The addressable electroluminescent display device according to claim 29 wherein the electroluminescent phosphor layer has a thickness in a range from about 0.2 to about 1.5 micrometers.

43. The addressable electroluminescent display device according to claim 29 wherein the electroluminescent phosphor layer is light emitting oxide phosphor selected from the group consisting of Zn₂Si_{0.5}Geo_{0.5}O₄:Mn, Zn₂SiO₄:Mn, or Ga₂O₃:Eu and CaAl₂O₄:Eu.

44. The addressable electroluminescent display device according to claim 29 wherein the electrically conductive, substantially transparent row electrode layers are indium tin oxide (ITO).

45. The addressable electroluminescent display device according to claim 29 wherein the electrically conductive electrode column layers are made of a metal selected from the group consisting of gold, silver, nickel and copper.

46. The addressable electroluminescent display device according to claim 29 wherein generally spherical dielectric particles are selected from the group consisting of strontium titanate (SrTiO₃) and lead zirconium-titanates (Pb(Zr,Ti)O₃).

47. The addressable electroluminescent display device according to claim 38 wherein the polymer is selected from the group consisting of polyethylene, polystyrene and polyester.
